(19) United States
(12) Patent Application Publication
(10) Pub. No.: US 2009/0152776 A1
(43) Pub. Date: Jun. 18, 2009

(54) Core/Shell Polymer and Fluoropolymer Blending Blown Film Process

(75) Inventors: Ralph Munson Aten, Chadds Ford, PA (US); Sharon Ann Libert, Hockessin, DE (US); Heidi Elizabeth Burch, Parkersburg, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/328,816

(22) Filed: Dec. 5, 2008

Related U.S. Application Data
(60) Provisional application No. 61/013,096, filed on Dec. 12, 2007.

(51) Int. Cl. B29C 49/00

(52) U.S. Cl. 264/563

(57) ABSTRACT

A process for extruding a partially crystalline melt-fabricable perfluoropolymer. The process comprises blowing film from a perfluoropolymer having polytetrafluoroethylene sub-micrometer particles dispersed therein. The perfluoropolymer composition is a core/shell polymer or a dispersion blend or a melt-mixed polymer.

### FIELD OF THE INVENTION

The present invention relates to a process for blown film. More particularly, the present invention relates to a core/shell polymer and or fluoropolymer blend for use in making blown film.

### BACKGROUND OF THE INVENTION

In making blown film, molten polymer is continuously extruded upward from a circular die to form a film tube, which is expanded by internal pressure, and which, at some height above the die (typically 10-50 times the diameter of the die), and after the film has cooled, is nipped, and wound up. Gas is injected into the film tube to maintain the internal pressure necessary for expansion. The expansion occurs in the section of the tube where the polymer is still melt-flowable, i.e. not crystallized or of such high viscosity that it no longer flows easily. When tetrafluoroethylene/perfluoro(alkyl vinyl ether) copolymer (PFA) is used in making blown film, the degree of expansion is limited by the melt strength of the film. If the melt strength is exceeded, a hole or holes will form in the film tube. Like PFA, tetrafluoroethylene/hexafluoropropylene copolymer (FEP) used in making blown film is similarly limited in expansion by the polymer melt strength.

It is desirable to provide a melt-fabricable perfluoropolymer that in the blown film process can be extruded rapidly to give a film of sufficient melt strength to allow for greater expansion than that possible with commercial PFA, FEP or other perfluoropolymers.

### SUMMARY OF THE INVENTION

Briefly stated, and in accordance with one aspect of the present invention, there is provided a process comprising (a) melting a partially crystalline melt-fabricable perfluoropolymer and extruding it into an annular shape, and (b) pneumatically expanding said shape while in a melt-flowable state, said perfluoropolymer containing an effective amount of dispersed sub-micrometer size PTFE particles to improve said extruding and expanding of said annular shape. The extruded partially crystalline melt-fabricable perfluoropolymer annular shape comprises a continuous length.

### BRIEF DESCRIPTION OF THE DRAWINGS

The invention will be more fully understood from the following detailed description, taken in connection with the accompanying picture, in which:

FIG. 1 shows the “lay flat” dimension @ 100 takeup for core/shell polymer (i.e. Example 1) compared to Teflon® PFA 440 HP.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

Perfluoropolymer compositions consisting of particles of polytetrafluoroethylene (PTFE) dispersed in melt fabricable perfluoropolymer are found to be useful in blowing film to greater expansion than is possible using the melt-fabricable perfluoropolymer by itself. These perfluoropolymer compositions may be the result of blending dispersions of PTFE and of melt fabricable perfluoropolymer as described in U.S. Patent Application No. 2007/0117930 (dispersion blends), or they may be the product of core/shell polymerization to make an aqueous dispersion of particles having a PTFE core and a melt processible perfluoropolymer shell, as described in U.S. Patent Application No. 2007/0117935 (core/shell polymers). In either case the dispersion is coagulated to separate the polymer from the dispersion medium; the polymer is isolated, dried, and preferably pelletized by melt extrusion, the pellets being convenient for feeding to blown film machines. The perfluoropolymer composition as the product of melt-mixing is described in U.S. Patent Application No. 2007/0117929 (melt-mixed polymers).

The melt-fabricability characterizing the core/shell polymer and the shell perfluoropolymer as well as the perfluoropolymer that, in the form of aqueous dispersion, is mixed with PTFE dispersion means that they are sufficiently flowable in the molten state that they can be fabricated by melt processing that involves subjecting the polymer to shear, such as extrusion and injection molding, to produce products having sufficient strength so as to be useful. One attribute of the strength is the ability to repeatedly flex film made from pellets made by melt blending of the core/shell polymer or of the dispersion blended polymer or melt-mixing, without cracking or breaking the film. In this regard the polymer preferably exhibits an MIT Flex Life (8 mil thick film) of at least about 500 cycles, more preferably at least about 1000 cycles, still more preferably at least about 2000 cycles and most preferably at least about 4000 cycles.

The PTFE polymer of the PTFE particles is not melt fabricable by conventional polymer processing methods such as extrusion and injection molding. Such PTFE is fabricated by sintering. This PTFE is not melt fabricable because it is not melt flowable. The non-melt flowability of the PTFE is characterized by high melt creep viscosity, sometimes called specific melt viscosity. This viscosity is determined by the measurement of the rate of elongation of a molten sliver of PTFE under a known tensile stress for 30 minutes, as further described and determined in accordance with U.S. Pat. No. 6,841,594, referring to the specific melt viscosity measurement procedure of U.S. Pat. No. 3,819,594. The molten sliver made in accordance with this test procedure is maintained under load for 30 minutes, before the measurement of melt creep viscosity is begun, and this measurement is then made during the next 30 minutes of applied load. The PTFE preferably has a melt creep viscosity of at least about 1×10⁶ Pa·s, more preferably at least about 1×10⁷ Pa·s, and most preferably at least about 1×10⁸ Pa·s, all at 380° C. The PTFE is preferably homopolymer but may be what is known as modified PFTE that is polymer of TFE with small amounts of comonomer such as HFP or PAVE, such amounts being insufficient to cause the melting point of the resulting polymer to be below 325° C. Comonomer amounts are preferably less than about 1 wt % of the combined TFE and comonomer weights in the polymer, and more preferably less than about 0.5 wt % of these combined weights. Also included in the class of PTFE polymer, according to this invention, is the sinterable, non-melt flowable modified PTFE having PAVE content of up to about 10 wt %. Such modified PTFE is described in U.S. Pat. No. 6,870,020.

The melt fabricable perfluoropolymer of the present invention includes copolymers of tetrafluoroethylene (TFE) with one or more polymerizable perfluorinated comonomers, such as perfluoroolefin having 3 to 8 carbon atoms, hexafluoropropylene (HFP), and/or perfluoro(alkyl vinyl ether) (PAVE) in which the linear or branched alkyl group contains 1 to 5 carbon atoms. Preferred PAVE monomers include perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/perfluoro(methyl vinyl ether)/perfluoro(propyl vinyl ether) copolymer, sometimes called MFA by the manufacturer. The preferred perfluoropolymers are TFE/HFP copolymer in which the HFP content is about 5-17 wt %, more preferably TFE/HFP/PAVE such as PEVE or PPVE, wherein the HFP content is about 5-17 wt % and the PAVE content, preferably PEVE, is about 0.2 to 4 wt %, the balance being TFE, to total 100 wt % for the copolymer. The TFE/HFP copolymers, whether or not a third comonomer is present, are commonly known as FEP. Also preferred are TFE/PAVE copolymers, generally known as PFA, having at least about 2 wt % PAVE of the total weight percent, including when the PAVE is PPVE or PEVE, and typically contain about 2-15 wt % PAVE. When PAVE includes PMVE, the composition is about 0.5-13 wt % perfluoro(methyl vinyl ether) and about 0.5 to 3 wt % PPVE, the remainder of the total of 100 weight percent being TFE, and as stated above, may be referred to as MFA.

The perfluoropolymers described above may have end groups that contain monovalent atoms other than fluorine, such as hydrogen, which may be introduced by chain transfer agents such as ethane or methanol, or the —CH₂OH group introduced by methanol chain transfer agent. Similarly, stabilizing of fluoropolymers by what is known as humid heat treatment, described in U.S. Pat. No. 3,085,083, converts such thermally or hydrolytically unstable end groups like —COF and —COOH, to the more stable —CF₂H group, thereby introducing hydrogen atoms at the end(s) of the polymer chains. Such polymers are conventionally considered perfluoropolymers, and are perfluoropolymers for the purposes of this invention.

The size of the PTFE particles influences the performance of the perfluoropolymer compositions of the present invention when those compositions are made by blending dispersions. Variations in PTFE particle size in the PTFE dispersion can be achieved by controlling the aqueous polymerization of tetrafluoroethylene (TFE) in ways known by those of skill in the art. PTFE particles in the PTFE dispersion blended with melt fabricable perfluoropolymer dispersion are preferably in the range of not less than about 10 nm in the longest dimension, more preferably not less than about 20 nm. The PTFE particles are preferably less than about 150 nm, more preferably less than about 125 nm, and most preferably less than about 100 nm.

For both the core/shell polymer and the dispersion blend polymer of the present invention, the PTFE component of the perfluoropolymer composition is at least about 0.1 wt % based upon the combined weights of the PTFE and the melt fabricable perfluoropolymer components. More preferably the PTFE is at least about 0.5 wt %, still more preferably at least about 1 wt %. The PTFE component preferably is not more than about 50 wt % based upon the combined weights of the PTFE and melt fabricable perfluoropolymer components. More preferably the PTFE component is not more than about 30 wt %, still more preferably not more than about 20 wt %, and most preferably not more than about 10 wt % based upon the combined weights of the PTFE and the melt fabricable perfluoropolymer components.

The perfluoropolymer composition of the invention, whether it is the result of melt mixing, dispersion blending or of core/shell polymer dispersion, is usually used in pelletized form. The dispersion blend or the core/shell polymerization is isolated, for example by coagulation, by freezing and thawing, or by addition of electrolyte such as aqueous nitric acid or ammonium carbonate, or by mechanical agitation. The aqueous medium is separated, the coagulate dried, and then melt extruded through a hole die, after which it is cut, either in the melt (melt cutting) or after cooling and solidification (strand cutting), to make pellets. In the pelletized form, the melt processible perfluoropolymer forms the matrix or continuous phase, and the PTFE particles, the discrete phase.

The melt flow rate (MFR) of the perfluoropolymers used in the present invention can vary widely, depending on the proportion of core PTFE, the melt-fabrication technique desired for the core/shell polymer, and the properties desired in the melt-fabricated article. It is possible for the MFR to be zero whilst still maintaining melt fabricability at higher shear rates due to the thixotropic nature of the perfluoropolymers used in the present invention. Hence, MFRs for the melt-fabricable perfluoropolymer can be in the range of about 0 to 500 g/10 min, but will usually be preferred as about 0 to 10 g/10 min, more preferably 0 to 100 g/10 min, and more preferably 0 to 50 g/10 min as measured according to ASTM D1238-94a and, following the detailed conditions disclosed in U.S. Pat. No. 4,952,630, at the temperature which is standard for the polymer. (See, for example, ASTM D 2116-91a and ASTM D 3307-93 that are applicable to the most common melt-fabricable fluoropolymers, both specifying 372° C. as the polymer melt temperature in the Plastometer®). The amount of polymer extruded from the Plastometer® in a measured amount of time is reported in units of g/10 min in accordance with Table 2 of ASTM D 1238-94a. For the perfluoropolymer composition made by dispersion blending, the MFR of the melt fabricable fluoropolymer is that of the melt fabricable fluoropolymer of the dispersion. For the perfluoropolymer composition made by core/shell polymerization, the MFR of the perfluoropolymer in the shell is determined by carrying out the polymerization of the perfluoromonomers used to form the melt fabricable perfluoropolymer by themselves, i.e. no core, using the same recipe and polymerization conditions used to form the shell, to obtain perfluoropolymer that can be used in the MFR determination.

As used in the specification hereinbelow, the term core/shell polymer has the following meaning. The core/shell polymer has a core of PTFE and a shell of TFE/PPVE. The shell polymer has a melting point of 305° C. and a MFR of 13 g/10 min (the composition and melt flow rate of the polymer of the shell that is similar to that of the commercial polymer Teflon® PFA 440 HP B (manufactured by DuPont, Wilmington, Del. USA)). The core/shell polymer has 5 wt % PTFE core and 95% PFA shell, with an MFR of 4.1 g/10 min. The PFA is made as described below.

### Test Procedures

The procedures for determining melt viscosity, melt flow rate (MFR), and MIT Flex Life are discussed herein. All of the core/shell polymers disclosed in the Examples exhibited a melt viscosity less than about 5×10⁴ Pa·s at 350° C. and a shear rate of 101 s⁻¹.

The thixotropy of the melt blends disclosed herein is determined by capillary rheometry method of ASTM D 3835-02 in which the melt temperature of the polymer in the rheometer is 350° C. This method involves the extrusion of molten polymer through the barrel of a Kayeness® capillary rheometer at a controlled force to obtain the shear rate desired.

The non-melt flowability of the PTFE can also be characterized by high melt creep viscosity, sometimes called specific melt viscosity, as described above, which involves the measurement of the rate of elongation of a molten sliver of PTFE under a known tensile stress for 30 min, as further described in and determined in accordance with U.S. Pat. No. 6,841,594, referring to the specific melt viscosity measurement procedure of U.S. Pat. No. 3,819,594. In this test, the molten sliver made in accordance with the test procedure is maintained under load for 30 min, before the measurement of melt creep viscosity is begun, and this measurement is then made during the next 30 min of applied load. The PTFE preferably has a melt creep viscosity of at least about 1×10⁶ Pa·s, more preferably at least about 1×10⁷ Pa·s, and most preferably at least about 1×10⁸ Pa·s, all at 380° C. This temperature is well above the first and second melt temperatures of PTFE of 343° C. and 327° C., respectively. As described above, MFRs for the melt-fabricable perfluoropolymer can be in the range of about 0 to 500 g/10 min, but are typically preferred in the range of about 0 to 100 g/10 min, and more preferably in the range of about 0 to 50 g/10 min as measured according to ASTM D1238-94a and, following the detailed conditions disclosed in U.S. Pat. No. 4,952,630, at the temperature which is standard for the polymer. (See, for example, ASTM D 2116-91a and ASTM D 3307-93 that are applicable to the most common melt-fabricable fluoropolymers, both specifying 372° C. as the polymer melt temperature in the Plastometer®).

The elongation at break and tensile strength are determined by the ASTM D 638-03 procedure on dumbbell-shaped test specimens 15 mm wide by 38 mm long and having a web thickness of 5 mm, stamped out from 60 mil (1.5 mm) thick compression molded plaques. The disclosures of elongation and tensile strength parameters and values herein are with reference to and are obtained by following this procedure using the compression molded plaques, unless otherwise indicated. The measurements on the blown film were made with dumbbell-shaped test specimens stamped from the film in the machine and transverse direction.

The procedure for measuring MIT Flex Life is disclosed by the ASTM D 2176 using an 8 mil (0.21 mm) thick compression molded film. The disclosures of the MIT Flex Life parameter and values herein are with reference to and are obtained using either an 8 mil (0.21 mm) or a 55 mil (1.4 mm) thick compression molded film. The compression molding of the plaques and film used in these tests was carried out on fine powder under a force of 20,000 lbs (9070 kg) at a temperature of 350° C. to make 6×6 in (15.2×15.2 cm) compression moldings. In greater detail, to make the 55 mil (1.4 mm) thick plaque, the fine powder was added in an overflow amount to a chase which was 60 mil (1.5 mm) thick. The chase defines the 6×6 in sample size. To avoid sticking to the platens of the compression molding press, the chase and fine powder filling are sandwiched between two sheets of aluminum foil. The press platens are heated to 350° C. This sandwich is first pressed for 5 min at about 200 lb (91 kg) to melt the fine powder and cause it to coalesce, followed by pressing at 10,000 lb (4535 kg) for 2 min, followed by 20000 lb (9070 kg) for 2 min, followed by release of the pressing force, removal of the compression molding from the chase and sheets of aluminum foil, and cooling in air under a weight to prevent warping of the plaque. The film samples used in the MIT test were ½ in (1.27 cm) wide strips cut from the compression molded film. Compression molding of the core/shell polymer coagulated and dried into fine powder produces the dispersion of the PTFE core in a continuous matrix of the shell perfluoropolymer. The compression molding is necessary to give the test specimen strength. If the powder were merely coalesced by heating at the temperature of the compression molding, to simulate the fusing of a coating, the resultant coalesced article would have little strength.

The solids content of raw (as polymerized) dispersion is determined gravimetrically by evaporating a weighed aliquot of dispersion to dryness and weighing the dried solids. Solids content is determined by dividing the weight of the dried solids by the weight of the aliquot, and is stated in weight %, which is based on combined weights of polymer and water. Alternatively, solids content can be determined by using a hydrometer to determine the specific gravity of the dispersion and then by reference to a table relating specific gravity to solids content. (The table is constructed from an algebraic expression derived from the density of water and density of as polymerized polymer.) Raw dispersion particle size (RDPS) is measured by photo correlation spectroscopy.

The shell perfluoropolymer composition is determined by infrared analysis on compression molded film made from the core/shell polymer particles in accordance with the procedures disclosed in U.S. Pat. No. 4,380,618 for the particular fluoromonomers (HFP and PPVE) disclosed therein. The analysis procedure for other fluoromonomers is disclosed in the literature on polymers containing such other fluoromonomers. For example, the infrared analysis for PEVE is disclosed in U.S. Pat. No. 5,677,404. The perfluoropolymer shell is made following the copolymerization recipe used to make the perfluoropolymer by itself. The perfluoropolymer composition of the core/shell polymers of the present invention, however, is determined on the entire core/shell polymer. The composition of the shell is calculated by subtracting the weight of the TFE consumed to make the PTFE core.

### Core/Shell Polymer Dispersion Preparation

The core/shell polymer has a core of PTFE homopolymer and a shell of TFE/PPVE copolymer. The shell polymer has a melting point of 305° C. and an MFR of 12 g/10 min as estimated from the results of similar polymerizations The core/shell polymer is made as follows: A cylindrical, horizontal, water-jacketed, paddle-stirred, stainless steel reactor having a length to diameter ratio of about 1.5 and a water capacity of 10 gallons (37.9 L) was charged with 54 pounds (24.5 kg) of demineralized water, 5 g Krytox® 157FSL, and 240 mL of a 20 wt % solution of ammonium perfluorooctanoate surfactant in water. With the reactor paddle agitated at 50 rpm, the reactor was evacuated and purged three times with tetrafluoroethylene (TFE). The reactor temperature then was increased to 75° C. After the temperature had become steady at 75° C., the pressure of the reactor was raised to 300 psig (2.1 MPa) using TFE. Four hundred milliliters of an initiating solution consisting of 0.2 wt % APS in water was injected to the reactor, then this same initiator was added at 5.0 mL/min. After polymerization had begun as indicated by a 10 psig (0.07 MPa) drop in reactor pressure, additional TFE was added at 0.2 lb (90.8 g)/min for 5 min. After 4 lb (1816 g) of TFE was fed after initiation, the TFE and initiator feeds were stopped, then the reactor was slowly vented. After stopping agitation, the reactor vapor space was evacuated. Agitation was resumed at 50 rpm, then the contents were cooled to 25° C. The agitator was again stopped, then the pressure in the reactor was raised to 8 in Hg (3.93 psig, 27.1 kPa) with ethane. After the addition of ethane, the agitator was restarted at 50 rpm and the contents of the reactor were warmed to 75° C. A 200 mL aliquot of perfluoro(propyl vinyl ether) (PPVE) was added, then the pressure in the reactor was raised to 250 psig (1.75 MPa) with TFE. For the duration of the reaction, PPVE was added at 2.0 mL/min and initiation was resumed using the same solution at a rate of 5 mL/min. The pressure of TFE in the reactor was continuously adjusted to maintain a reaction rate of 0.167 lb TFE/min (75.7 g/min). After 16 lbs (8618 g) TFE reacted in 96 min, the reaction was terminated by stopping TFE, initiator, and PPVE feeds, then venting the reactor. Solids content of the dispersion was 29.3 wt %, and the raw dispersion particle size (RDPS) was 0.105 μm. After coagulation, the polymer was isolated by filtering and then dried in a 150° C. convection air oven. This core/shell polymer had detectible melt flow rate (MFR) (2 g/10 min), a PPVE content of 4.59 wt %, melting points of 306 and 326° C., and an MIT flex life of 395879 cycles. The core shell polymer also exhibited a tensile strength of 4126 psi (28.4 MPa) and elongation at break of 338%. The PTFE core content was 4.8 wt %, and the viscosity difference was 8505 Pa·s. The core/shell polymer has 5 wt % PTFE core and 95% PFA shell, with an MFR of 4.1 g/10 min. The PFA is made as described above in Example A.

### PFA Dispersion Preparation

The composition and melt flow rate of the PFA polymer of the example is similar to the commercial polymer Teflon® PFA 440 HP B (available from E. I. du Pont de Nemours & Co., Wilmington, Del.). The aqueous dispersion of copolymer of tetrafluoroethylene and perfluoro(propyl vinyl ether) (PFA dispersion) is made as follows:

A cylindrical, horizontal, water-jacketed, paddle-stirred, stainless steel reactor having a length to diameter ratio of about 1.5 and a water capacity of 10 gallons (37.9 L) was charged with 54 pounds (24.5 kg) of demineralized water, and 240 mL 20 wt % solution of ammonium perfluorooctanoate surfactant in water. With the reactor paddle agitated at 50 rpm, the reactor was evacuated and purged three times with tetrafluoroethylene (TFE). Ethane was added to the reactor until the pressure was 8 in Hg (3.93 psig, 27.1 kPa), then 200 mL of perfluoro(propyl vinyl ether) (PPVE) were added. The reactor temperature was then increased to 75° C. After the temperature had become steady at 75° C., TFE was added to the reactor to achieve a final pressure of 250 psig (1.75 MPa). An aliquot of 400 mL of a freshly prepared aqueous initiator solution containing 0.2 wt % of ammonium persulfate (APS) was charged to the reactor. This same initiator solution was pumped into the reactor at 5 mL/min for the remainder of the batch. After polymerization had begun, as indicated by a 10 psig (0.07 MPa) drop in reactor pressure, additional TFE was added to the reactor at a rate of 0.167 lb/min (75.6 g/min) until a total of 20 lb (9080 g) of TFE had been added after kickoff. PPVE was added at 2.0 mL/min for the duration of the batch, 120 min. At the end of the reaction period, the TFE, PPVE, and initiator feeds were stopped and the reaction vessel was vented. When the reactor pressure reached 5 psig (0.035 MPa), the reactor was swept with nitrogen, then the reactor contents were cooled to 50° C. before the dispersion was discharged from the reactor. The solids content of the dispersion was 37.0 wt %, and the raw dispersion particle size (RDPS) was 0.200 μm. For purposes of analysis, a portion of the dispersion was coagulated and the polymer was isolated by filtering. The polymer was and then dried in a 150° C. convection air oven. This TFE/PPVE copolymer had a melt flow rate (MFR) of 11 g/10 min, a PPVE content of 3.85 wt %, melting points of 305° C. and 328° C., and an MIT flex life of 1355 cycles. The tensile strength of the PFA was 4086 psi (28.2 MPa) and the elongation at break was 358%.

### PTFE Dispersion Preparation

This procedure describes the aqueous homopolymerization of tetrafluoroethylene to make PTFE dispersion. A cylindrical, horizontal, water-jacketed, paddle-stirred, stainless steel reactor having a length to diameter ratio of about 1.5 and a water capacity of 10 gallons (37.9 L) was charged with 54.0 pounds (24.5 kg) of demineralized water, 240 mL of a 20 wt % solution of ammonium perfluorooctanoate surfactant in water, and 5.0 g Krytox® 157 FSL, available from E.I. du Pont de Nemours and Company, Inc. Krytox® 157 FSL is a perfluoropolyether carboxylic acid as further described in Table 1 of U.S. Pat. No. 6,429,258. With the reactor paddle agitated at 50 rpm, the reactor was heated to 60° C., evacuated and purged three times with tetrafluoroethylene (TFE). The reactor temperature then was increased to 75° C. After the temperature had become steady at 75° C., the pressure of the reactor was raised to 300 psig (2.07 MPa) using TFE. Four hundred milliliters of an initiating solution consisting of 0.20 wt % APS in water was injected to the reactor, then this same initiator was added at 5.0 mL/min. After polymerization had begun as indicated by a 10 psig (0.07 MPa) drop in reactor pressure, additional TFE was added at 0.2 lb (90.8 g)/min for 1.0 min. After 0.2 lbs (90.8 g) of TFE had been fed after initiation, the TFE and initiator feeds were stopped and the reactor was vented. The contents of the reactor were cooled to 50° C. before being discharged. The solids content of the dispersion was 1.36 wt % and the raw dispersion particle size (RDPS) was 25 nm.

### FEP Dispersion Preparation

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water and 330 mL of a 20 wt % solution of ammonium perfluorooctanoate surfactant in water. With the reactor paddle agitated at 46 rpm, the reactor was heated to 60° C., evacuated and purged three times with tetrafluoroethylene (TFE). The reactor temperature then was increased to 103° C. After the temperature had become steady at 103° C., HFP was added slowly to the reactor until the pressure was 444 psig (3.1 MPa). Ninety-two milliliters of liquid PEVE was injected into the reactor. Then TFE was added to the reactor to achieve a final pressure of 645 psig (4.52 MPa). Forty milliliters of freshly prepared aqueous initiator solution containing 1.04 wt % of ammonium persulfate (APS) and 0.94 wt % potassium persulfate (KPS) was charged into the reactor. Then, this same initiator solution was pumped into the reactor at 10 mL/min for the remainder of the polymerization. After polymerization had begun as indicated by a 10 psig (0.07 MPa) drop in reactor pressure, additional TFE was added to the reactor at a rate of 24.5 lb (11.1 kg)/125 min until a total of 24.5 lbs (11.1 kg) of TFE had been added to the reactor after kickoff. Furthermore, liquid PEVE was added at a rate of 1.0 mL/min for the duration of the reaction. The total reaction time was 125 min after initiation of polymerization. At the end of the reaction period, the TFE feed, PEVE feed, and the initiator feed were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. Solids content of the dispersion was 36.81 wt % and raw dispersion particle size (RDPS) was 0.167 μm. A portion of the dispersion was coagulated to produce material for testing. After coagulation, the polymer was isolated by filtering and then drying in a 150° C. convection air oven. This polymer was stabilized by heating at 260° C. for 1.5 hr in humid air containing 13 mol % water. The TFE/HFP/PEVE terpolymer (FEP) had a melt flow rate (MFR) of 37.4 g/10 min, an HFP content of 10.5 wt %, a PEVE content of 1.26 wt %, and a melting point of 260° C. For this material, the viscosity change (reduction), Δη, was 101 Pa·s. The FEP exhibited a tensile strength and elongation at break of 2971 psi (20.8 MPa) and 310%, respectively. This is a typical preparation of a high-performing FEP. FEP is believed to perform similar to PFA in creating blown film.

### Blown Film:

Perfluoropolymer composition from core/shell polymer is blown into film using a Brabender ¾ inch (19 mm) extruder featuring a screw with 25:1 length to diameter ratio and a 3:1 compression ratio. The extruder end is connected to a one inch outside diameter (25.4 mm) die. The gap between the die tip and die head is 0.030 inches (76 μm). The extruder temperature profile is the following:

| | |
|---|---|
| Zone 1 | 340° C. |
| Zone 2 | 350° C. |
| Zone 3 | 370° C. |

Die Temperature 370° C.

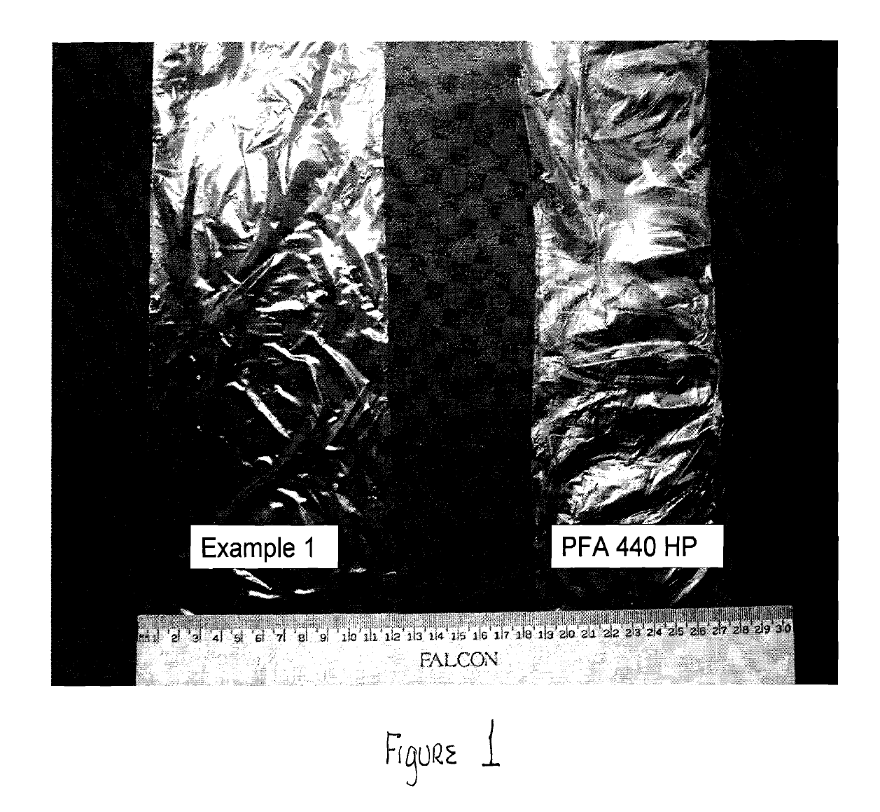

Film was extruded and taken up at 60 rpm in the first run, and at 100 rpm in two subsequent runs. When the extrusion was running smoothly, a one meter length of the blow film was cut out and measured. The film thickness (mm) was measured at eight evenly spaced intervals and the mean, standard deviation, and coefficient of variation (CoV, obtained by dividing standard deviation by mean) are calculated. The “lay flat” width (cm) was measured at 10 cm intervals along the length of the one meter run sample, and the mean, standard deviation, and coefficient of variation are calculated. By “lay flat” is meant the blown film after it has passed through the nip rolls, which press it to flat sheet form. FIG. 1 shows the more uniform “lay flat” dimension of Example 1 in comparison to that of Teflon® PFA 440 HP. Example 1 is the core/shell polymer whose measurements are shown in Table 1, Run 3. Twice the width of the flat sheet is the circumference of the blown film tube before it reached the nip rolls. Dividing the circumference by π (pi) gives the diameter of the blown film tube. Dividing the blown film tube diameter by the extrusion die diameter in centimeters, give the “blowup ratio”. The blown film results are summarized in Table 1 below. The core/shell polymer used in Tables 1-3 are prepared as described above in the section labeled “Core/Shell polymer Dispersion Preparation”.

TABLE 1

| | | Core/Shell Polymer | | | Teflon ® PFA 440 | | |
|---|---|---|---|---|---|---|---|
| | | Thickness | Lay Flat | Blowup | Thickness | Lay flat | Blowup |
| | | (mm) | Width (cm) | Ratio | (mm) | width (cm) | Ratio |
| Run 1 | mean | 0.0286 | 10.74 | 2.69 | 0.054 | 8.59 | 2.15 |
| (60 rpm) | CoV (%) | 20.6 | 9.1 | 9.1 | 35.0 | 20.0 | 20.0 |
| Run 2 | mean | 0.0127 | 10.76 | 2.70 | 0.0349 | 9.44 | 2.37 |
| (100 rpm) | CoV (%) | 0.0 | 4.4 | 4.4 | 25.8 | 7.7 | 7.6 |
| Run 3 | mean | 0.0381 | 11.84 | 2.97 | 0.0556 | 8.77 | 2.2 |
| (100 rpm) | CoV (%) | 0.0 | 3.5 | 3.7 | 36.5 | 13.2 | 13.2 |

The perfluoropolymer composition from core/shell polymer yields a thinner-walled film than does Teflon® PFA 440 (manufactured by E. I. du Pont de Nemours & Co., Wilmington, Del.). This is shown in the thickness results of Runs 1-3 of Table 1. Additionally, there is less variation in film thickness in the core/shell polymer than Teflon® PFA 440 (“PFA 440”) as shown by the coefficient of variation (CoV) in Table 1. Furthermore, the blowup ratio is greater with core/shell polymer film then PFA 440. However, similar to the thickness CoV, the CoV of the blowup ratio has much less variation for the core/shell polymer than that of the PFA 440. One of the advantages of greater blowup ratio is that greater diameter film (or wider film if the extruded film tube is slit longitudinally) can be made with a given die, reducing the cost of the die in relation to film width. The ability to make thinner film results in reduced polymer cost per unit area film produced. Greater thickness uniformity results in improved film clarity and contributes to the ability to make thinner film without hole formation because the variation in thickness around the average film thickness is less.

In contrast, attempts to make thinner film or to achieve a greater blowup ratio with PFA 440, led to “blow outs” of the film, i.e. hole formation. In addition, the appearance of the blown film from the core/shell polymer shows greater clarity than the film made from PFA 440.

The blowup ratio for the blown film is preferably at least about 2.4, more preferably at least about 2.45, still more preferably at least about 2.5, even more preferably at least about 2.6, and most preferably at least about 2.69. The coefficient of variation of thickness is preferably less than about 10%, more preferably less than about 5%, and most preferably less than about 4%. The coefficient of variation of thickness is preferably less than about 25%, preferably less than about 20%.

The ability to blow thinner, more uniform film as shown by the present invention, allows for more economic film product, both 1) because thinner film uses less polymer and 2) because the greater blowup ratio permits the use of smaller, less costly, extruder dies to blow film of a given diameter of if slit, width.

TABLE 2

| | | | Core/Shell | Teflon ® | Core/Shell | Teflon ® |
|---|---|---|---|---|---|---|
| | | | polymer @ | 440 HP @ | polymer @ | 440 HP @ |
| Mechanical | | ASTM | 60 rpm | 60 rpm | 100 rpm | 100 rpm |
| Property | Direction | Method | Takeup | Takeup | Takeup | Takeup |
| Ultimate | Machine | D-882 | 5804 | 5265 | 5348 | 4032 |
| Tensile | Transverse | | 3122 | 1917 | 3172 | 2657 |
| Strength | | | | | | |
| (psi) | | | | | | |

Table 2 shows the comparison of the core/shell polymer (i.e. contains 5 wt % PTFE) and commercially available PFA 440 HP that has no PTFE at 60 rpm takeup and at 100 rpm takeup, respectively. The core/shell polymer has a higher value for ultimate tensile strength in the transverse (TD) and machine directions (MD) than does PFA 440HP as shown in Table 2.

The tensile strength is determined by the ASTM D 638-03 procedure on dumbbell-shaped test specimens 15 mm wide by 38 mm long and having a web thickness of 5 mm, stamped out of the blown film in the machine and transverse direction.

It is therefore apparent that there has been provided in accordance with the present invention, a process for blown film using fluoropolymer core/shell or a fluoropolymer blend or melt mixed polymer that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

It is claimed:

1. Process comprising (a) extruding a partially crystalline melt-fabricable perfluoropolymer into an annular shape, and (b) pneumatically expanding said shape while in a melt-flowable state, said perfluoropolymer containing an effective amount of dispersed sub-micrometer size PTFE particles to improve said expanding of said annual shape.

2. The process of claim 1, wherein said annular shape has continuous length.

3. The process of claim 1, wherein improving said expanding of said shape produces reduced variation in thickness of said shape.

4. The process of claim 1, wherein improving said expanding of said shape results in said shape having improved uniformity of thickness.

5. The process of claim 1, wherein said expanding of said annular shape by a process for making blown film creates a film.

6. The process of claim 1, wherein the effective amount of PTFE is at least 1 wt % of the combined wt % of PTFE and the perfluoropolymer.

7. The process of claim 5, wherein said film has a greater tensile strength in both machine and transverse directions than a film made using said process wherein said perfluoropolymer does not contain said PTFE particles.

8. The process of claim 1, wherein said perfluoropolymers is PFA.

9. The process of claim 1, wherein said perfluoropolymers is FEP.
